(19) United States
(12) Patent Application Publication
(10) Pub. No.: US 2024/0265319 A1
(43) Pub. Date: Aug. 8, 2024

(54) Automatically Updating Scheduling Software with Notification & Alerts

(71) Applicant: Joshua MAY, Portland, OR (US)

(72) Inventor: Joshua MAY, Portland, OR (US)

(21) Appl. No.: 18/420,758

(22) Filed: Jan. 24, 2024

Related U.S. Application Data
(60) Provisional application No. 63/443,302, filed on Feb. 3, 2023.
(60) Provisional application No. 63/534,201, filed on Aug. 23, 2023.
(60) Provisional application No. 63/541,677, filed on Sep. 29, 2023.

(51) Int. Cl. G06Q 10/0631; G06Q 10/10; G06Q 50/08

(52) U.S. Cl. CPC G06Q 10/063114; G06Q 10/103; G06Q 50/08

(57) ABSTRACT

Improvements to construction software that automatically updates construction scheduling software, is viewable through a UX operating system, which displays critical information, and disseminates live updates and directives via alerts to all stakeholders and team members with both status and next step directives. The software creates schedule updates directly into the software and includes updates through linked, document driven status updates, sensory based schedule updates utilizing AI and machine learning. Trade mounted sensors that actively view work status, UAV/Drone/Robot integrated systems with sensors that regularly inspect status of project and factory-built assemblies. The system utilizes, Gantt chart oversite, driven by task management field updates, linked to Geo-Spatial location. The system provides updates with cloud-based applications, confirming a task is complete, documenting its location to help others find it based on satellite location with one's phone or mesh networks. Include updating documents (i.e. Digital pre-functional checklists, inspection forms etc.).

### CROSS-REFERENCE TO RELATED APPLICATIONS

This application claims the benefit of Provisional Application Ser. No. 63/534,201 filed Aug. 23, 2023, Provisional Application Ser. No. 63/443,302 filed Feb. 3, 2023, and Provisional Application Ser. No. 63/541,677 filed Sep. 29, 2023, the entire contents of which is hereby expressly incorporated by reference herein.

### PRIOR ART

U.S. Publication Number 2013/0132440 was published on May 5, 2015, to Alan Carlson et al, and is titled Arrangements for Administrating and Managing a Construction Project. This publication discloses a construction project administration system and method are disclosed that queries an administrator as to ownership, construction specifications, bidding parameters etc. for a proposed construction project using active first, second and third level questions and accepts and stores replies to the active questions. The stored replies can be compared to predetermined answers, and questions that become irrelevant based on the answers can be deactivated and taken off a list of questions to be asked. The system can auto-configure a process for online construction management. For example, a website can be set up that can be used by all parties to the project to automate communications, the exchange of data, status updates etc. including the submission of bids, acceptance of bids, and the award of contracts and many more paperless construction management features. While this publication is for exchanging information it does not include a graphical interface for tracking the status of a project nor does it include artificial intelligence that updates the schedule using sensors.

U.S. Publication Number 2011/0213631 was published on Sep. 1, 2011, to Edward Ruben Mislavsky and is titled System and Method for Performing Project Management Attendant to any of Various Types of Projects. This publication discloses a system, method, and computer-readable-storage medium for performing project management of, and/or attendant to, one or more projects; each project including a set of tasks. The system may include a server having a framework adapted to configure the server to manage one or more aspects (e.g., any of a scope, cost, and schedule) of, and/or attendant to, any project and/or portion thereof. For example, the server may obtain, from one or more users, information associated with the set of tasks; apply one or more directives of the framework to the information to determine one or more states of, and/or attendant to, the managed aspects; compare the managed-aspect states to respective sets of predetermined conditions; and report at least an indication of the managed-aspect states responsive to such satisfying the sets of predetermined conditions. While this publication provides a computer system for tracking the interface is not graphical to use the floor plans as the basis of determining the status and progress of a construction project.

What is needed is a construction software technology solution that provides construction software that automatically updates construction scheduling software, is viewable through a common operating system UX, that displays critical information, and disseminates live updates and directives via alerts to all stakeholders and team members with both status and next step directives. The automatically updating scheduling software with notification & alerts disclosed in this document provides the solution.

### BACKGROUND OF THE INVENTION

In construction projects using a common interface that allows for collaborating, and evolving, internet services provided the right media and became the common platform for communication, share knowledge, technologies and having a single platform where all parties can determine the project status and any discrepancies from the schedule to enhance development. Modules are used to optimize automated computer program(s) that use artificial intelligence to track and update project status will aid in project tracking.

### SUMMARY OF THE INVENTION

It is an object of the construction software technology solution to provide construction software that automatically updates construction scheduling software, is viewable through a common operating system UX, that displays critical information, and disseminates live updates and directives via alerts to all stakeholders and team members with both status and next step directives.

It is an object of the automatically updating scheduling software with notification & alerts to provide a program that creates an advantage through eliminating manual schedule updates that are directly imputed into the commonly used software and instead includes updates that are implemented through linked, document driven status updates, sensory based schedule updates utilizing AI and machine learning, trade mounted sensors that actively view work status, UAV/Drone/Robot integrated systems with sensors that regularly inspect status of project and factory built assemblies.

It is another object of the automatically updating scheduling software with notification & alerts to use Gantt chart oversite that is driven by task management field updates, linked to Geo-Spatial location. The system can provide updates with cloud-based applications, confirming that a task is complete, documenting its location to help others quickly find it based on satellite location with one's phone or mesh networks to amplify pinpoint accuracy within the project map.

It is another object of the automatically updating scheduling software with notification & alerts to utilize Building Information Modeling (BIM) to set up variable data fields within associated system documents (Schedule, Inspection, Building Permit, Building Material Order sourcing, as architects, and engineers (i.e. Structural, Civil, Mechanical, Electrical, etc.) that work together to populate a scaled version of complete projects and systems to design buildings with a fully realized 3/D model prior to construction, this is a powerful tool to also utilize to document project completeness from a design, estimate, submittal, pre-construction, construction post construction and other phases.

It is still another object of the automatically updating scheduling software with notification & alerts to utilize artificial intelligence (AI) and machine learning that will be utilized as an option to identify construction completeness through field sensors, the system will learn to identify when tasks are complete and will update the schedule directly and or alert appropriate team members, including but not limited to schedulers, supervisors/superintendents, field engineers, project managers, tradesmen, trades-managers, stakeholders, owners, vendors, delivery agencies, city and state agencies, investors, etc. This will initiate the next step/subsequent activities that would typically utilize human input/interaction.

It is still another object of the automatically updating scheduling software with notification & alerts to utilize the Gantt schedule that can also be substituted or utilized with a critical path methos (CPM), program evaluation & review technique (PERT), Kanban, scrum, agile release train (ART), time-boxing, burndown charts, or story mapping, feature-driven development (FDD), digital pull plan or digital calendar.

It is still another object of the automatically updating scheduling software with notification & alerts to have a web site with built-in scheduling tools that would utilize industry techniques, with a Gantt chart and calendar updates with a pull plan that has the capability to cross references between Gantt chart and calendar views. The system includes push notifications. Dates move automatically with a daily request of status of activities through app/email to all assigned team members. Artificial intelligence that is based upon sensory input through drones, human team members with sensors track updates.

It is still another object of the automatically updating scheduling software with notification & alerts to have the ability to scan floor plans that can be digitally or physically extruded quickly to manipulate into 3D where the model can be marked-up and linked into the schedule. The 3D model can be quickly rotated, and stacked in the isometric view that can be quickly updated with data/progress notes with ability to highlight zones in detail in 3D. 3D mapping cameras can be mounted to hard hat(s), persons, or drones to constantly map jobsite environment using GPS to understand project status as well as safety/QC.

It is still another object of the automatically updating scheduling software with notification & alerts where in “clicking” on a task in the Gantt chart will link to elevation/plan view or equipment schedule depending on quick select option and it to 3D statuses map following a daily walk through.

It is another object of the automatically updating scheduling software with notification & alerts to utilize artificial intelligence and machine learning to scan design documents, such as architectural, mechanical, electrical, civil, structural, etc. drawings, or design analysis documents such as the “Owner's Project Requirements, “The Basis of Design”, “Soils Reports” and other Specifications, with the ability to create baseline schedule examples, for example we know that virtually all buildings require, some form of foundation, if the project is new, it would suggest lot clearing, survey, excavation, placement of footing rebar, inspections, and placing concrete.

The system would prompt the user for any critical information that is not available, for example additional curing time of concrete to provide a more robust schedule example. The system would also link recommended digital documents that then push the schedule as they are completed. Each task has a weighted and a assigned relative value, for example pouring concrete has a relative weighted value of 10, whereas we know that the structural rebar that needs to be set in place prior to pouring concrete must always be placed prior to the concrete step/activity, thus it would be assigned a value in this instance of 9, so the computer implemented process has a built in process that would create the weighted arrangement of tasks in the correct order and should the project experience delays, the program would not only utilize the linked predecessor and successor logic, it has the capacity to logically reoriented activities, phases and groups based on the weighted and assigned logic process.

To take this function a step further weighting of activities is not limited to predecessor and successors activities, as an example, the rebar activity that was assigned with a value of 9, is equal to other activities of the same weight, thus setting forms across a large soon to be placed foundation would have a value of 8 (setting prior to rebar) or 9, as the activity could be done based on phasing concurrently with setting forms, as a result of this logic path, the program shall considering weighting of activities that are not hard linked via schedule successor ties which assists the users with logical scenarios for schedule recoveries when delays are encountered, during schedule creation or updates.

This capability extends beyond single activities, as phases of work are weighted against other stages of work to create a based logic scheduling logic, for example, if one is pouring a large foundation across three scheduled and subsequent phases, if the second phase is delayed, the computed implemented method would revert to the weighted phase schedule to push the next slab pour phase into place with all subsequent logic calculated. The system will also calculate the status of work complete through machine learning through several examples of image detection status, for example, a frame wall with studs that are spaced 16″ apart will be a baseline example, as the program is presented with an opening, in this case that frames out a door, which is typically 3′ wide by 7″ tall, the program will learn and know that as a sensor based upload of a wall that has that opening type will confirm within the program that the task of framing the weighted door opening is complete, this will subsequently status the schedule, and any associated digital checklists.

It is another object of the automatically updating scheduling software with notification & alerts to extend beyond construction, to all industries that at utilize project management driven operations that utilize scheduling metrics driven software, examples include but are not limited to the industries of aerospace, automotive, manufacturing, corporate Tech, agriculture, design by using UX at Gantt entry, selections; wheel, flow/isometric/rotate profile with options, etc.

It is another object of the automatically updating scheduling software with notification & alerts for schedule Gantt bar digital tasks to be linked to the document Selection option to become selectable when hovering over any part of the task, Wheel around Gantt bar to select type of document to link for percentage of task complete, examples include but are not limited to the following digital forms with status completion tasks (note that tasks are divided by 100, once all tasks are completed the schedule registers the status of task as complete and has the option to auto apply task as complete, thus updating the entire schedule with all affected predecessors and successors updating live or when the system is prompted to update, this feature can also be locked by task, by the admin if further confirmation is required digital document examples, this would include but are not limited to inspection, Quality Control—Completion, readiness, commissioning, PFC, PVT and FPT forms.

It is still another object of the automatically updating scheduling software with notification & alerts to use the PERT method of analyzing the tasks involved in completing a given project, especially the time needed to complete each task, and to identify the minimum time needed to complete the total project. It incorporates uncertainty by making it possible to schedule a project while not knowing precisely the details and durations of all the activities. It is more of an event-oriented technique rather than start- and completion-oriented and is used more in those projects where time is the major factor rather than cost. It is applied on very large-scale, one-time, complex, non-routine infrastructure and on Research and Development projects. The PERT is a management tool which relies on arrow and node diagrams of activities and events: arrows represent the activities or work necessary to reach the events or nodes that indicate each completed phase of the total project”.

Various objects, features, aspects, and advantages of the present invention will become more apparent from the following detailed description of preferred embodiments of the invention, along with the accompanying drawings in which like numerals represent like components.

### BRIEF DESCRIPTION OF DRAWINGS

FIG. 1 shows a transparent isometric view of a building.

FIG. 2 shows a project overwatch screen of a floor from the building in FIG. 1.

FIG. 3 shows a Gantt chart for a building project.

FIG. 4 shows the stages of a construction project.

FIG. 5 shows the stages for drywall installation and release.

FIG. 6 shows an inspection.

FIG. 7 shows other operations and checklists.

FIG. 8 shows an example of a preferred project creation flowchart.

FIG. 9 shows a checklist document for one aspect of the project.

FIG. 10 shows a screenshot of a document being created.

FIG. 11 shows a PERT network chart for a seven-month project with five milestones and six activities.

FIG. 12 shows a check list with a drop down shown in the right panel.

FIG. 13 is a flow chart according to example 2.

### DETAILED DESCRIPTION OF THE INVENTION

It will be readily understood that the components of the present invention, as generally described and illustrated in the drawings herein, could be arranged and designed in a wide variety of different configurations. Thus, the following more detailed description of the embodiments of the system and method of the present invention, as represented in the drawings, is not intended to limit the scope of the invention but is merely representative of various embodiments of the invention. The illustrated embodiments of the invention will be best understood by reference to the drawings, wherein like parts are designated by like numerals throughout.

Item Numbers and Description

| | | | |
|---|---|---|---|
| 20 | OverWatch screen | 21 | architectural example |
| 22 | blue | 23 | red |
| 24 | visual pulse | 25 | schedule |
| 26 | isometric view | 27 | panel |
| 28 | project phase | 29 | activity sheet |
| 30 | floor | 31 | floor plan |
| 32 | third floor | 33 | bar graphs |
| 40 | different layers | 41 | stages |
| 42 | drywall | 44-49 | activities |
| 50 | Gantt chart | 55-59 | milestones |
| 60 | selected | 61 | CxA selected |
| 62 | Draft Cx Plan | 63 | Review BOD/OPR |
| 64 | Develop Cx specifications | 65 | Design Reviews |
| 66 | NTP | 70 | Construction phase |
| 71 | Cx Kick-off meeting | 72 | Cx Schedule |
| 73 | Finalize Cx Plan | 74 | Submittal Reviews |
| 75 | O & M Review | 76 | Training plan review |
| 77 | Start-Up | 78 | Ready for functional testing |
| 79 | Start-up | 80 | Component testing |
| 81 | Ready for functional testing | 82 | Testing / Training phase |
| 83 | Issues resolution / re-testing | 84 | Owner training |
| 85 | Building turnover | 86 | Occupancy phase |
| 87 | Develop systems manual | 88 | Cx Documentation |
| 90 | Drywall contract awarded | 91 | drywall begins |
| 92 | drywall complete | 93 | drywall ready to inspect |
| 94 | GC verify drywall complete | 95 | Super request drywall inspection |
| 96 | Verify drywall complete | 97 | Update & release GC to continue |
| 98 | GC releases successor activity | 100 | inspector |
| 102 | camera | 104 | clip board / tablet |
| 106 | sensor | 110 | drone |
| 200 | open software | 201 | program flow chart |
| 202 | select project | 210 | Project 1 |
| 211 | Project 2 | 212 | Project 3 |
| 220 | schedule | 230 | link task |
| 231 | add activity | 240 | assign users |
| 242 | commissioning | 245 | Issue Log (create) |
| 251 | number of units | 260 | pre-functional checklist |
| 261 | update checklist | 262 | update document |
| 270 | pre-verification tests | 280 | functional performance tests |
| 300 | checklist document | 301 | checklist number |
| 302 | checklist description | 310 | timeline thumbnail |
| 311 | progress block | 320 | acknowledgement |
| 321 | percent complete | 322 | system description |
| 323 | detailed description | 324 | type |
| 325 | asset | 330 | contractor declaration |
| 340 | readiness declaration | 350 | document print date |
| 400 | document screenshot | 405 | activities |
| 410 | project headers | 415 | activities |
| 420 | start date | 425 | finish date |
| 430 | float duration | 440 | critical path |
| 442 | activity timeline | 444 | activity |
| 450 | tabs | 452 | activity |
| 454 | activity type | 456 | resources |
| 500 | flow chart | 502 | pre-functional checklist (PFC) |
| 504 | initialize AHU-2 PFC | 506 | calculate completion |
| 508 | update Gantt chart | 510 | % completion |
| 512 | No | 514 | Yes, done |
| 516 | complete | 518 | ID dependent tasks |
| 520 | adjust start / end dates | 522 | propagate changes |
| | | 522 | propagate changes |

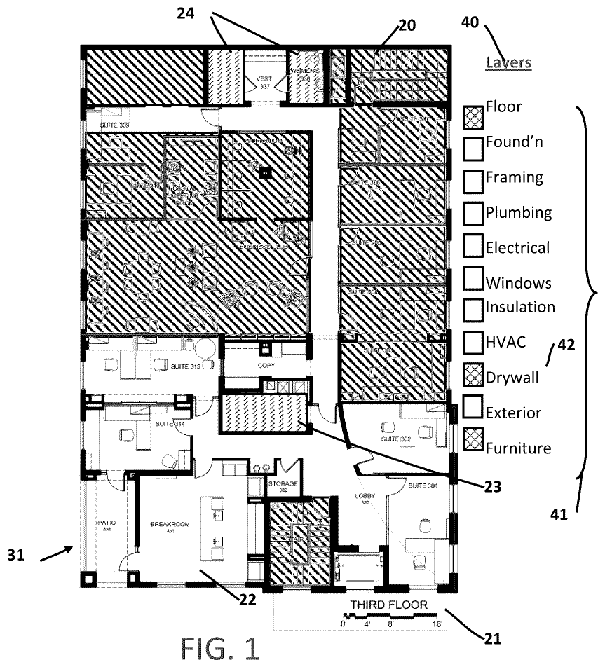

FIG. 1 shows a project OverWatch screen 20. The project OverWatch screen 20 shows a semi-transparent isometric architectural example 21 of a project. Different colors are used to provide a visual indicator of work status and progress as work is completed and critical areas. From the semi-transparent isometric architectural example 21 a floor 30 can be selected to view status of the floor plan. In this example, the third floor 32 is selected and the floor plan is shown on the OverWatch screen. Common zoom, rotation and plan features can be used to look at specific areas of floor plan 31.

The OverWatch screen that automatically updates construction scheduling software, is viewable through a common operating system UX, that displays critical information, and disseminates live updates and directives via alerts to all stakeholders and team members with both status and next step directives.

The floor plan 31 and isometric architectural example 21 are created with the project creation by scanning the floor plans that can be extruded quickly to manipulate into 3D where the model can be marked-up and linked into the schedule. The 3D model can be quickly rotated, and stacked in the isometric view that can be quickly updated with data/progress notes with ability to highlight zones in greater detail in 3D. The GPS location of floors and rooms are automatically associated with the floor plan. The system uses Gantt chart oversite that is driven by task management field updates, linked to Geo-Spatial location. It can also allow for a virtual view through the building as is known prior art from some architectural design programs using 3D goggles.

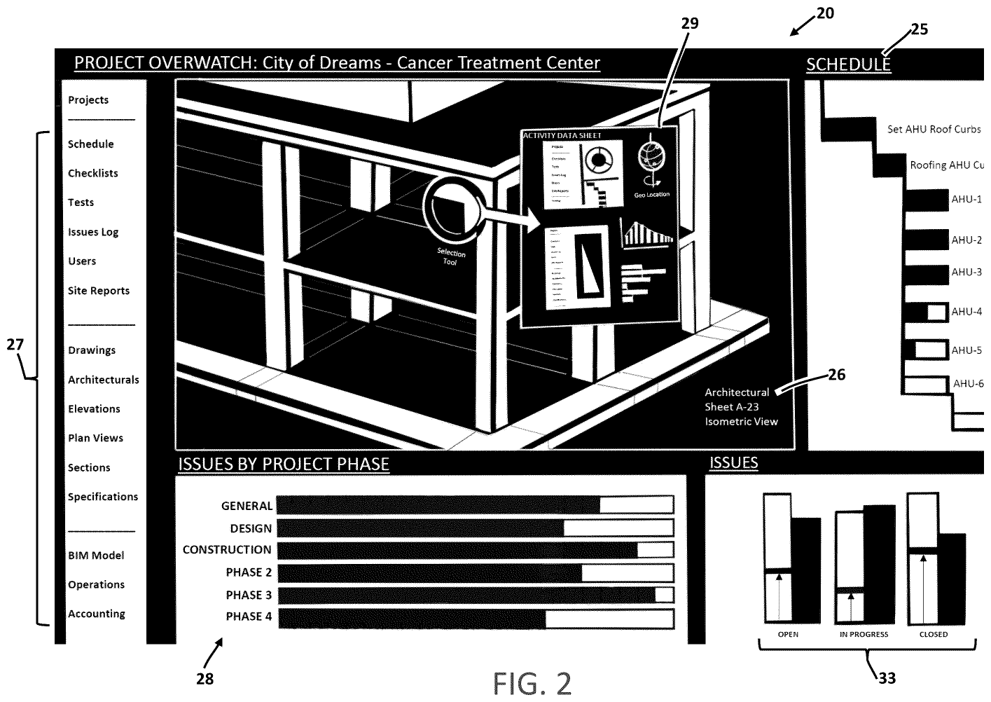

FIG. 2 shows a project overwatch screen of a floor from the building in FIG. 1 showing an isometric view 26 with an activity sheet 29. From this screen various attributes of the schedule can be selected from the panel at the left of the screen. The right panel shows the schedule for the project with Gantt chart for the elements of the project. The issues by project phase 28 is shown on the bottom panel. The panel in the lower right shows bar graphs 33 for the issues that are open, in progress and closed.

As an example, work that is in progress will be visually blue 22 with critical areas are highlighted 23. Areas ready for inspection or in need of attention will show up with a visual pulse 24 or flashing. The coloring and pulsing are determined by linking documentation inputs to vectors that are overlayed within the Building Information Modeling (BIM) process.

Along with the floor plan, layers 40 can be viewed for different layers 40 for stages 41 of construction. In this example different layers can be turned on or off for layers of the floor plan, foundation, framing, plumbing, electrical, windows, insulation, HVAC, drywall, exterior and furniture. Alternatively, it is contemplated to utilize architectural plans or templated examples of different project types with more general indications of project readiness, for example, foundations, floor framing, mechanical systems, roofing, etc. In this example, the floor plan, drywall, and furniture layers are selected.

The user interface and interacts with the construction software technology solution must provide simple, clear, and accurate information with notifications that the appropriate group(s) want so they can interact with on a regular basis. The construction software technology solution indicates when critical activities have been completed and subsequent activities must begin.

The program uses and links commonly utilized scheduling software programs, (that may have registered trademark names) including, but not limited to Oracles P6, Microsoft's Project and Smartsheet's which utilizes a spreadsheet/scheduling system, management software programs such as Procore that track all construction software, utilizing a custom developed system as well as a licensable plug-in software stack.

The system utilizes, Gantt Chart Oversite, driven by task management field updates, linked to Geo-Spatial location. The system can provide updates with cloud-based applications, confirming that a task is complete, documenting its location to help others quickly find it based on satellite location with one's phone or mesh networks to amplify pinpoint accuracy within the project map.

Utilize BIM (Building Information Modeling) to set up variable data fields within associated system documents (Schedule, Inspection, Building Permit, Building Material Order sourcing, as architects, and engineers (i.e. Structural, Civil, Mechanical, Electrical, etc.) work together to populate a scaled version of complete projects and systems to design buildings with a fully realized 3/D model prior to construction, this is a powerful tool to also utilize to document project completeness from a design, estimate, submittal, pre-construction, construction post construction and other phases.

AI and machine learning will be utilized as an option to identify construction completeness through field sensors, the system will learn to identify when tasks are complete and will alert appropriate team members, including but not limited to schedulers, supervisors/superintendents, field engineers, project managers, tradesmen, trades-managers, stakeholders, owners, vendors, delivery agencies, city and state agencies, investors, etc. This will initiate the next step/subsequent activities that would typically utilize human input/interaction.

From this example, two bathrooms on the outside of the building show up with a visual pulse 24 or flashing indicate that the areas ready for inspection or in need of attention. In addition, the bathroom in the middle of the floor plan is shown as a critical area and are highlighted 23 for drywall 42. Turning on or off other layers, such as plumbing or electrical may provide additional information regarding why drywall is a critical area. The information in the OverWatch screen, floor plan and project are linked to a Gantt chart that is created for the project.

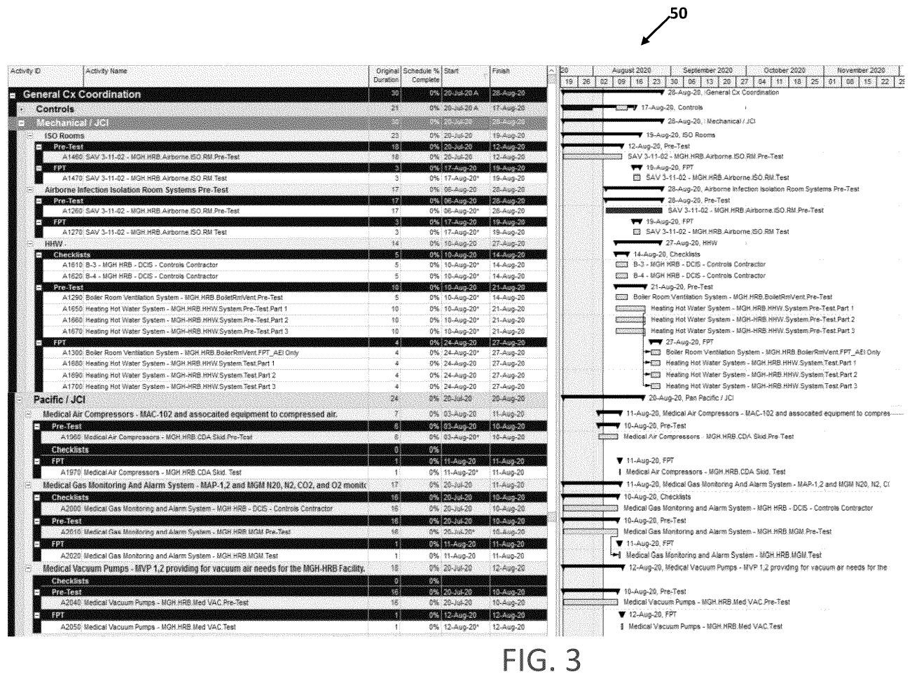

FIG. 3 shows a Gantt chart 50 for a building project. The different layers 40 for stages 41 are linked to the Gantt chart whereby the critical area is highlighted 23 for drywall 42 is highlighted in the Gantt chart. The level of detail in the Gantt chart can reflect the drywall issue by the whole project, a specific floor or as detailed as a specific room on a specific floor. A high level of detail is preferred when an inspection identifies a discrepancy in one room that is not critical to the entire floor but needs to be repaired. The system can provide updates with cloud-based applications, confirming that a task is complete, documenting its location to help others quickly find it based on satellite location with one's phone or mesh networks to amplify pinpoint accuracy within the project map.

The system is capable of using complementary PERT and CPM tools because “CPM employs one time estimation and one cost estimation for each activity; PERT may utilize three-time estimates (optimistic, expected, and pessimistic) and no costs for each activity. Although there are distinct differences, the term PERT is applied increasingly to all critical path scheduling tools.

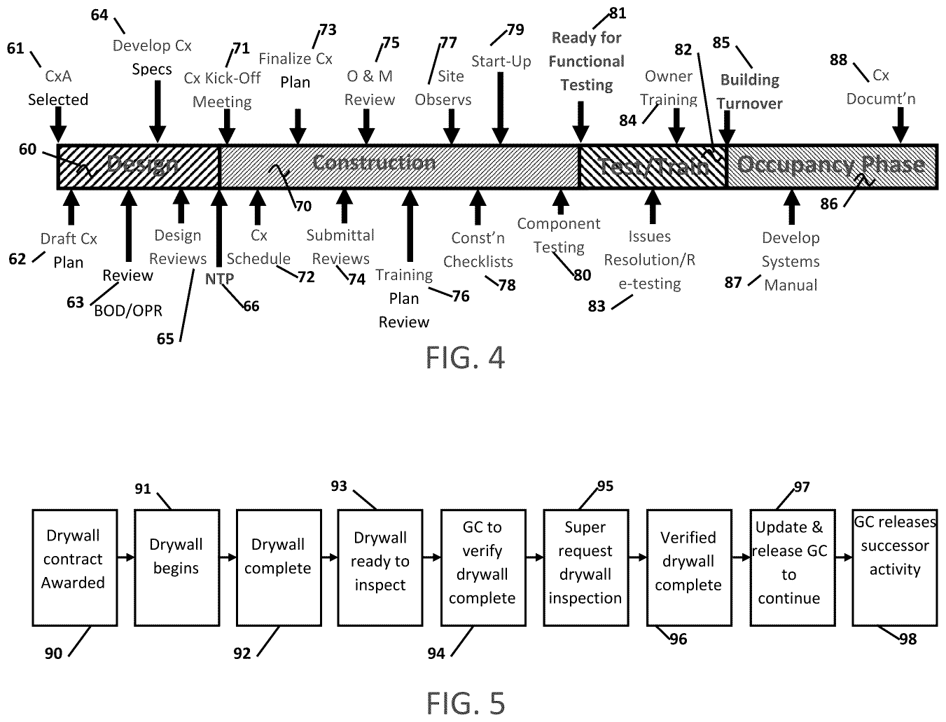

FIG. 4 shows a timeline for a complete project from when a construction CxA agency is selected 61 in the design 60 stage to the completion of construction Cx documentation 86 in the occupancy phase 84. The timeline is broken into pieces as a Gantt chart (as shown in FIG. 3) is created to track and follow the incremental steps of a project.

For every project a construction agency CxA 61 is selected, usually from a bidding process to design 60 a building structure of other project. A plan for the design is drafted as a draft Cx plan 62. The plan is reviewed for the Basis of Design (BOD)/Owner's Project Requirements (OPR) 63 and approved. From the plan the construction company will develop Cx specifications 64. There is a design review(s) 65 and the project transitions at NTP 66.

As construction begins there is a Cx kick-off meeting 71 and a Cx schedule 72 is created for the complete project. There is a finalized Cx plan with submittal reviews 74 and an Operation and Maintenance (O & M) review 75 followed by a training plan review 76. There is a site observation 77 where construction check lists 78 are created. When sufficient progress is made with the project there will be a start-up 79 with component testing 80 and the project will be ready for functional testing 81 and the project will enter a testing and training phase 82.

In the testing and training phase any identified issues will have been resolved and re-tested 83. There will be owner training 84 that ensures the building owners understand the components in the facility and how they operate as well as maintaining the equipment before the building is turned over 85 to the owners or tenant.

In the occupancy phase 86 there will be a development of systems manual(s) 87. The Cx will provide documentation 88 for the entire building at completion of the project. This broad overview of the steps provides a macro background for handling a project. This document will then look at a micro component of the schedule as a drywall project in a building, floor, or room. Referring to the floor plan in FIG. 2, two bathrooms were identified as being areas ready for inspection or in need of attention and will show up with a visual pulse 24 or flashing when the drywall layer was selected.

FIG. 5 shows the stages for drywall installation and release. A sub-contractor is selected for drywalling, and a drywall contract is awarded 90. The drywall job begins 91, in this example each floor or room has a separate start or begin date based upon when the general contractor releases a successor activity 98. Typically, a drywall job transitions from room-to-room or floor-to-floor as the prior activities are completed such as framing, electrical, HVAC, plumbing, insulation etc. that are usually complete before being covered by drywall. When the drywall installation is complete 82 it is ready for inspection 93 by notifying field engineer/field supervisors or others.

The general contractor or appropriate party will verify is the drywall is complete 94 by the supervisor requesting drywall inspection 95. When the drywall is verified as complete 96 there will be an update and release to the general contractor to continue. The general contractor will release successor activity, such as final electrical, final plumbing, flooring, or painting. As a further micro step in the process the verification of the drywall being complete 96 is performed by an inspection as diagramed in the next figure.

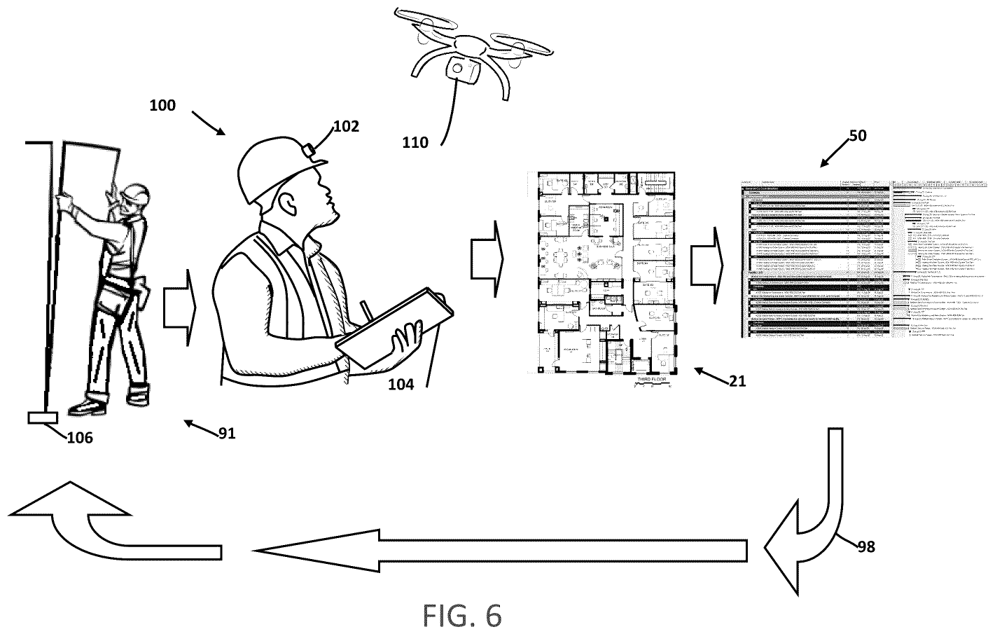

FIG. 6 shows an inspection. Starting at the left side of this figure, the drywall begins 91. Depending upon the installation a sensor 106 may detect that the installation has been completed, thereby completing the verification process. Site installed sensors 106 track construction status and sensory based schedule updates utilizing artificial intelligence and machine learning, trade mounted sensors that actively view work status, UAV/Drone/Robot integrated systems with sensors that regularly inspect status of project and factory-built assemblies.

There may be a manual or visual inspection by an inspector 100 or a drone 110 that can document the job is complete or they can record the installation and record with a camera 102 any areas that need correction. The GPS location of the inspector 100 and drone 110 is tracked to floor plan 21. Alternatively, or complementary a tablet 104 can be used with the floor plan 21 to record discrepancies, take pictures and send a verification that the drywall is complete 96 though the OverWatch screen. Because the information is exchanged in real time the Gantt chart 50 is immediately updated and the general contractor can request or review images that the drywall is complete 96.

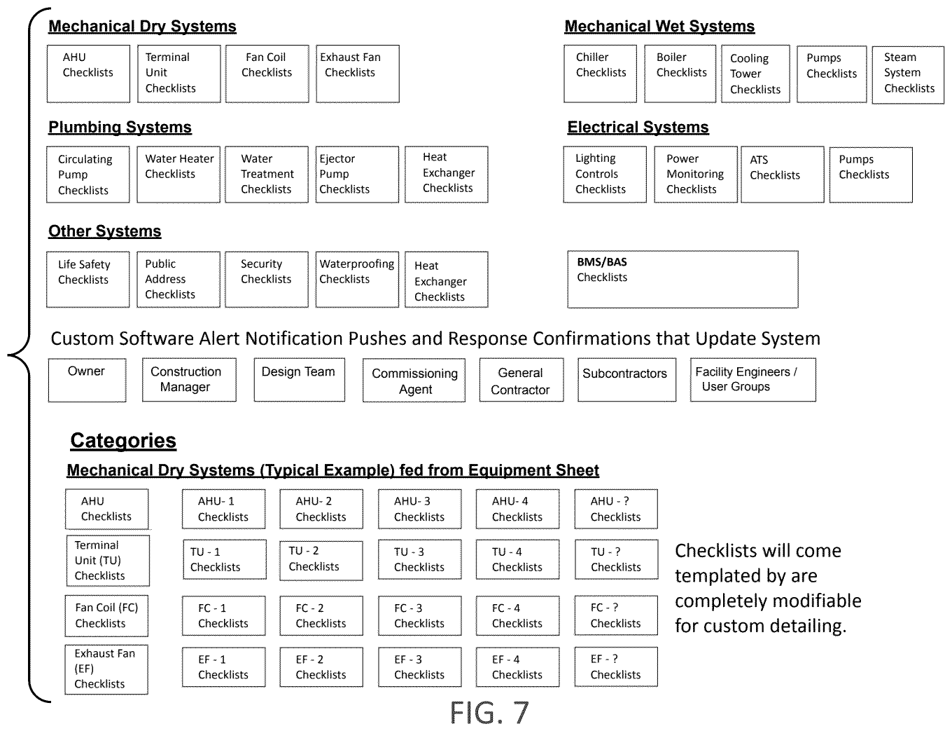

As the Gantt chart 50 is updated in the OverWatch screen the general contractor can release successor activities 98 that will again begin a drywall 91 or other activity. Data moves automatically with a daily request of status of activities through app/email to all assigned team members. This is just an example of a single operation of the OverWatch program and FIG. 7 shows many of the other operations and checklists that are contemplated. The checklists are templated and are completely modifiable for custom detailing.

The OverWatch program can have filters for project manager UX, contract management, sub-contract status, budget control, general superintendent UX, and quality control.

When a construction inspector 100 receives a notification (within his/her email, application, headset, or his smart glasses), integrated with the integrated construction software solution, indicating that the 16th floor's drywall installation 91 is completed within the new hospital or other structure is under construction.

As the construction inspector 100 walks the floor, the augmented reality (AR) overlay, powered by the software, highlights areas that are completed (The notification was made via trade through the software or mobile application, UAV drone 110, or individual shareholder who took a picture that was interpreted by machine learning/AI). Construction inspector 100 can immediately focus on these areas, streamlining the inspection process as he can see the work that should be completed and the checklist and schedule within the visual field of the augmented reality (AR) system.

The system's Artificial Intelligence (AI) provides the inspector with a checklist based on previous inspections including any reported previous issues that need to be verified, ensuring he, she, or the machine, doesn't miss out on any critical checkpoints. As the sections are denied, approved, or updated with real-time updates sent out to appropriate stakeholders that can be viewed in the Gantt chart 50 or other tracking mechanism.

As a function of the Augmented Reality (AR) interface as viewed through the headset, or smart glasses, a visual representation of the work that is or should be complete is overlayed with an AR perspective from the BIM model or AI representing scheduled work status, there is also a visual checklist displayed that the inspector can update via their view/gaze within field of view with one or stereo cameras 102 and the ability to confirm work complete, incomplete, percent complete or other notes or issues through visual ques or headset forward interpretations against the visual model for confirmation based on hand, head, limb or audible input confirmations.

The augmented reality function with an overlay that is visible showing missing work, which should be in place highlighted in field of view to complete inspection or status work. The overlay view shows highlighting completed work per schedule that can be status as complete or with the percentage of work completion, updating system schedule. The overlay of the schedule is visible in virtual Augmented Reality (AR) view including past punch-list issues or general Quality Control (QC) issues. The system can also reference code, specifications, contract documents, and best practices of the status of work to assist users or AI with recommendations or decisions on the heads-up display and or with verbal recommendations. Virtual AR view you through device, including tablet, phone, etc. Upon inspections or checklist confirmations, time stamp to BIM/drawings as well as check sheets AR showed what's missing and overlays with date in view cross referencing against BIM.

As an example of machine learning of schedule delay avoidance feature, the system provides for schedule delay anticipation and provides notifications, and analysis for correcting such as providing alternatives including additional workforce, overtime, and contract delay notifications in advance with penalties (direct and liquidated damages, potential). As well as alternatives such as moving other concurrent activities into priority queues to minimize delays or makeup time.

The system can provide through algorithm and or AI/Machine learning, notifications to vendors on ordering equipment or materials for last-minute/on-time deliveries (preferred in construction due to limited space/storage).

It is contemplated to use one or more modes and features for user-related confirmations vs AI/machine learning. While several modes are identified and described, other modes are anticipated.

Mode One—Gatekeeper: Trade or shareholder notification via app, sent to gatekeeper (can be multiple if desired: i.e., scheduling professional, project manager, superintendent, etc. . . . ) to review status notification along with appropriate uploaded information such as pictures for review.

Mode Two—Non-Gatekeeper or Utilization of both: Trade notification through application or software digital updates directly updates the system schedule and provides direction notification to appropriate/assigned stakeholders with the next steps.

Mode Three—Non-Gatekeeper & AI/Machine Learning: Trade or shareholder notifications, utilizing the use based on permissions of updating system schedule with notifications based on a mixture of gatekeeper approval, or direct automated approval or AI/Machine learning analysis and approval.

Mode Four—Compete AI/Machine learning input based on sensors 102: All previous modes can be enabled as deemed appropriate, Mode four introduces the ability to also update the system completely through sensory inputs 102 both passively (on hard hats etc.) or directly through roaming UAV's 110 and ground based programmed robots, or sensors 106 for inputting data that is then automatically updated to the system, analyzed by the AI/Machine learning with all appropriate schedule updates and notifications.

BIM Mode—The BIM mode feature allows the system to constantly compare the status of inputs vs. the 3/D or 2/D construction models creating a 4/D (Space and Time) system for accurate comparisons, this can also feed directly into Augmented reality for easy project status comparisons.

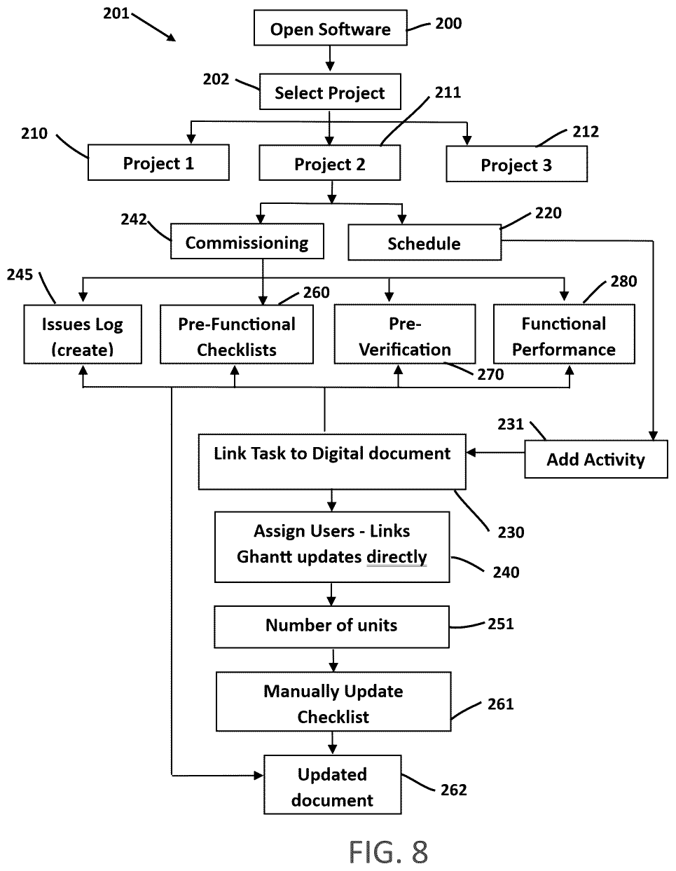

FIG. 8 shows an example of a preferred project creation flowchart 201. This flow chart provides an overview of a preferred embodiment, but other alternative embodiments are contemplated. When the software for the project creation is opened 200 the user can select an existing project 202, can create a new project, as an example, project 1, or can copy elements of a prior project, such as project 2 211 or project 3 212. There will be a commissioning 242 where a variety of tasks are created like issues log 245 that are created. Continuing with project 1 210 there are different attributes, and in this flowchart the focus is on schedule 220 that will add activity 231 for example HVAC that includes a start and a finish date. A project name is associated with making differentiation of different projects easier. The project name could be a number and/or a text description but could also be a picture or sound. Each project has a start date and one or several activities such as HVAC that includes a start and a finish date.

After selecting document type, the system will prompt user for more details, as an example, if commissioning was selected, document selection would give a range of options, if you select a pre-functional checklist, the system will prompt for division, in this scenario, you could pick mechanical systems, a drop down of mechanical equipment would then be propped by the system to choose type of equipment, examples would include Air Conditioning Units, Terminal Units, Exhaust Fans, etc. This in turn would link to either modifiable templates in the system, a custom modifiable form, or the option to upload a digital form that can be scanned and modified through Artificial intelligence and machine learning to quickly create a usable pre-made form, as another option a PDF can simply be uploaded with the option to note as incomplete or complete to then push the schedule task.

Once selected the system would prompt for a number of units and if they are the same type, and then a prompt of who is responsible to fill out the document, note several trades and personnel may need to sign off on different components of the form. As an example, an electrician, mechanical contractor and controls contractor would all need to sign off their section of the digital document, additionally the system includes another mini schedule prompt that notifies trades and stakeholders of work within the PFC that has completed that previously prevented their work with a notification that the work is either on schedule (noting the schedule start date) delayed or complete all with notifications that are usable to the appropriate stakeholders.

Submittals can also be linked to automatically push the scheduled tasks, for example, as submittals are tracked within the systems workflow, they will show the typical status of incomplete or complete when uploaded to the system with the option to choose either. This in turn can update the submittal schedule activities automatically, additionally if submittals are in their final approved form, the system will further push notification to vendors for material procurement notifications driven by the logic and dates noted within the schedule.

There are link task(s) with activities that could include, but not be limited to plumbing, including a finish date. Additional activities can be added to the link task(s) 230. The tasks are based on category and specific assets. There will be an auto status that will link digital documents, and asset dates. Each task is updated based upon a 0 to 100% completion that is shown linked from below with updates to the documents 262. The updates are based on 0 to 100% completion with automatic updated status of the schedule, and Gantt chart activity. At this stage there will be an assignment of users 240 linked to the Gantt chart for updates that are directly linked to documents with status for responsibilities and notifications etc.

Looking at the specific task of commissioning there are asset type(s) for the HVAC examples of, but not limited to, air handling unit, terminal unit, etc. This task shows several tasks for a particular asset. The number and type of tasks can be selected from preset forms or can be entered manually. In this example the asset identifies how many units 251 (HVAC) are needed and the format can be duplicated for each individual HVAC unit. This template can be replicated for additional units. The flowchart shows a pre-functional/construction checklist 260 followed by a manually updated checklist. The manually updated checklist can also be automated with sensors, a check list, and using artificial intelligence (AI) 261. There is also a function for updating the document on a 1-100% completion that automatically updates the status of the schedule in the Gantt chart activity 262 that flows back to the update task. Sensor automation can also confirm the status and tasks and updates that are linked to digital documents through computer implemented machine learning.

The pre-verification test 270 includes a separate, but similar, check list that also updates the schedule based upon completion and flows back to the update task. There is also functional performance test 280 that includes a checklist with its own schedule based upon completion and flows back to the update task.

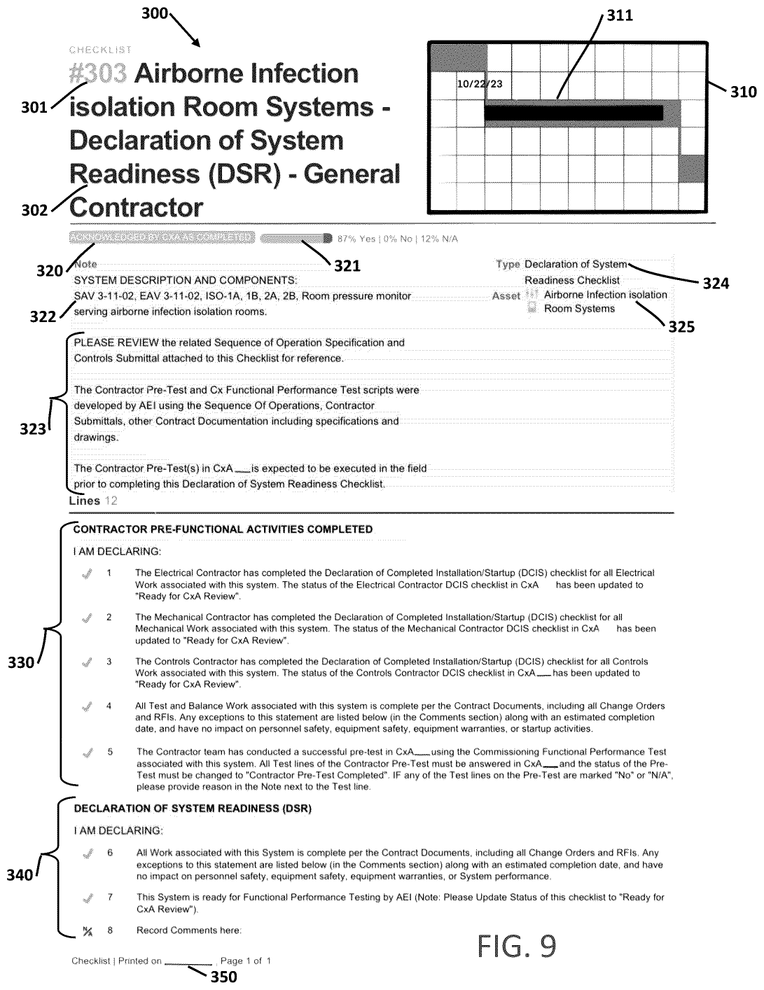

FIG. 9 shows a checklist document for one aspect of the project. This document is for an airborne infection isolation room system—declaration of system readiness (DSR)—general contractor 300 and has a unique checklist identifier 301 that is identified as #301. To the right of the title of the checklist #303 description is an abbreviated timeline thumbnail chart 310 with a progress block 311. A start date of Oct. 22, 2023 is shown on the chart along with progress on the task. Below the description is an acknowledgement 320 along with a bar showing the percent completion 321 of the task.

Below acknowledgement 320 and bar 321 is detailed information regarding the checklist. The detailed information includes a system description and components. There is also a description of the tests and functions that are required 323. This is followed by declarations from the contractor pre-functional activities completed by check list. In addition, there is a declaration of system readiness (DSR). The checklist page also includes the date printed 350 so the so the accuracy and timeliness of the document is easily determined.

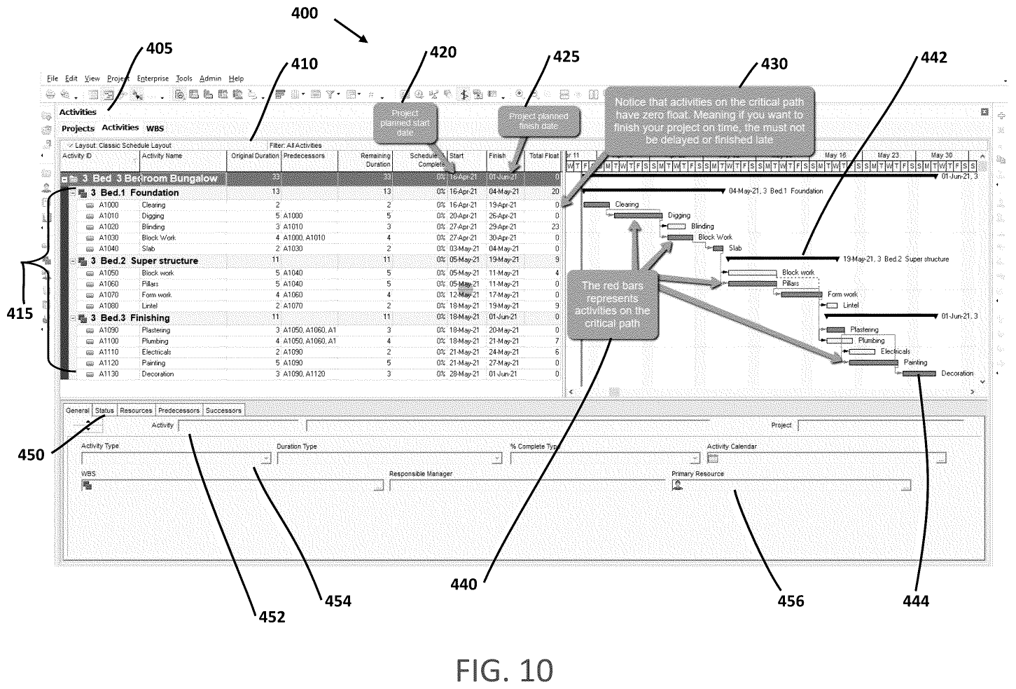

FIG. 10 shows a document screenshot 400 of a document being created. The schedule is the first step that link RFI's and submittals as milestones to the workflow as they affect schedule. The document can be viewed in calendar mode with all forms of schedule teaching in lieu of Gantt. This also includes customized Gantt via email that can be modified in email or app for trades to view only their tasks and provide status feeding back to schedule or admin to approve. Include proof points such as photos. Linked documents (i.e., pre-functional checklist shows initiates schedule status from Gantt chart at top of document including, on time/late/days left or exceeded.

In this screenshot 400 the application shows activities 405 with projects, activities and WBS. This project has a classic schedule layout with project headers 410. It shows several different activities 415 that have an activity ID, an activity name, original duration, predecessors, remaining duration, the percent of completion, the project planned start date 420 and the project planned finish date 425 along with the total float duration 430. The bars represent activities on the critical path 440. As an example, in the chart there is an activity timeline for the super structure 442 that has a scheduled start date 420 on May 5, 2021, with an 11-day duration, thereby yielding a finish date 425 of May 19, 2021. Within the Bed.2 Super structure there are four tasks included in the 11-day duration. The schedule is shown ending with activity 444 for decoration in the critical path.

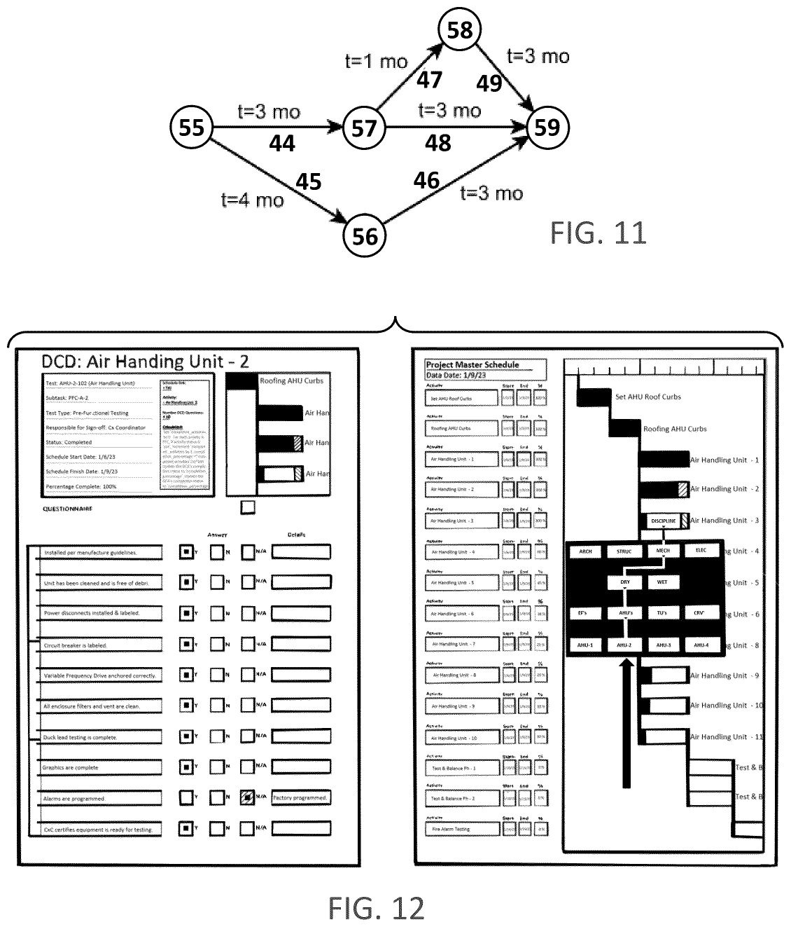

FIG. 11 shows a PERT network chart for a seven-month project with five milestones 55-59 and six activities 44-49. The creation of the chart can be constructed with preloaded templates based on the industry, for example construction templates for framing, plumbing, electrical. In an aerospace example the templates can be for engine components, fuselage, control with default timelines, for example making tooling may historically take 4 months, while engine testing can take 9 months. The PERT template items and timelines could fill with previously known or default values that can be modified.

The templates can make auto corrections/suggestions within activity field when creating Gannt activity. Using P6 to organize status of completion, for integration with this scheduling and tracking program, which is a spreadsheet with ability to add documents such as email, pictures, PDF's etc. It integrates program evaluation and review technique into the method of how the software can process the updates vs Gantt views and processes. As shown in this figure the PERT network chart shows a seven-month project with five milestones 55-59 and six activities 44-49. The program evaluation and review technique (PERT) is a statistical tool used in project management which was designed to analyze and represent the tasks involved in completing a given project and interlinks the milestones and activities to provide updates and schedule changes as the activities are completed. The schedule automatically expands and contracts the timeline and milestones based upon completion or delays and can provide the critical path to completion of milestones and the project, and in this example a 7-months from milestone 55 to milestone 59 with tasks 45 and 46 being the critical path to the 7-month schedule.

Below the schedule there are additional field tabs 450 with activity 452, activity type 454 along with primary resources. 456. This is shown as an example of one charting for an activity or projects, but additional features and functions are contemplated.

The software technology provides a dynamic set of relationships where the DCDs (Digital Checklist Documents) provide granular data on the completion status of specific tasks. When certain tasks within a DCD are completed, the completion percentage of the associated GCA (Gantt Chart Activity) is updated. There is GCA (Gantt Chart Activity) that in turn represents broader milestones or activities in the overall project Gantt chart. The completion of a GCA can influence the start date or status of other GCAs due to dependencies. The overall Schedule (represented by the entire Gantt chart with all its activities) provides a macro view of the project timeline. Updates in individual GCAs will affect the entire schedule, especially if there are delays or accelerations in task completions. When the overall schedule or individual GCAs are updated, this data back feeds into the DCDs, providing trades or users with an updated context of their tasks in relation to the entire project timeline.

This creates a feedback loop where the details from the DCDs impact the GCA, the GCAs together shape the overall schedule, and changes in the overall schedule then influence the data and context provided in the DCDs to provide a circular relationship ensures that all stakeholders, from tradespeople on the ground to project managers overseeing the entire venture, have the most current and accurate view of the project's status and timeline. Several examples are provided that give detail on the operation of the software technology.

In example 1, the software starts with a commissioning example on a construction project, assuming there are many AHU's—Air Handling Units. We have the digital Pre-Functional Checklist (PFC), in this case we will use AHU-1 PFC, which on this unit has 10 activities (assume activities such as for example Installed per spec, Unit Filters Installed, Unit Clean, Electrical Connections Complete, act as example questions) You can respond with a check box to the right of each question with a Yes, No or N/A. Assume there is a link to a Gantt schedule that is populated with 100 various activities reflecting the work on the site. There is a Gantt activity associated with AHU-1 PFC (Pre-Functional Checklist), as each activity is checked yes, 10% of the Gantt activity will update 10% complete. As the last activity is checked, the status will update to 100% and will trigger the Gantt activity and run the overall schedule, or update all activities with logic to status successors, predecessors, milestones etc. This software solution pertains to updating a Gantt chart based on the completion of a pre-functional checklist (PFC) or digital checklist including inspection digital document, quality control document etc.

There is first a setup with a pre functional checklist (PFC) is established with a number of activities. For this example, there are 10 activities. Each activity has a status of ‘yes’, ‘no’, or ‘n/a’. Each activity corresponds to a Gantt chart activity (GCA) that is associated with the PFC.

The algorithm initializes with all activities set to 0. When an activity in the PFC is completed, the completed activities increment by 1. The percentage complete is recalculated based upon (completed activities/the number of activities)*100. The Gantt Chart Activity (GCA) is then updated to show the new completion percentage. If the GCA is at 100% then it will trigger an update in the affected predecessors, milestones, successor etc., within the Gantt chart.

The scheduling logic will identify dependent task and adjust the start and end dates based upon the Gantt Cart Activity (GCA) completion status. The changes will then propagate to all subsequent tasks. The software system will be able to handle changes in the pre-functional checklist (PFC) (i.e., if an item that was previously marked as ‘yes’ is now ‘no’ or ‘n/a’. The Gantt chart's scheduling logic considers constraints and dependencies when updating task dates.

FIG. 12 shows a check list with a drop down shown in the right panel. This example is for a DCD air handling unit 2 where in the left screen the tasks are identified with Yes, No or Not applicable answers. From the right screen the start and end dates are given with a percentage of completion from 0 to 100%. Selecting a specific air handling unit (as example air handling unit 3) will drop down a detailed chart of activities wherein each activity can be further interrogated or viewed for the status.

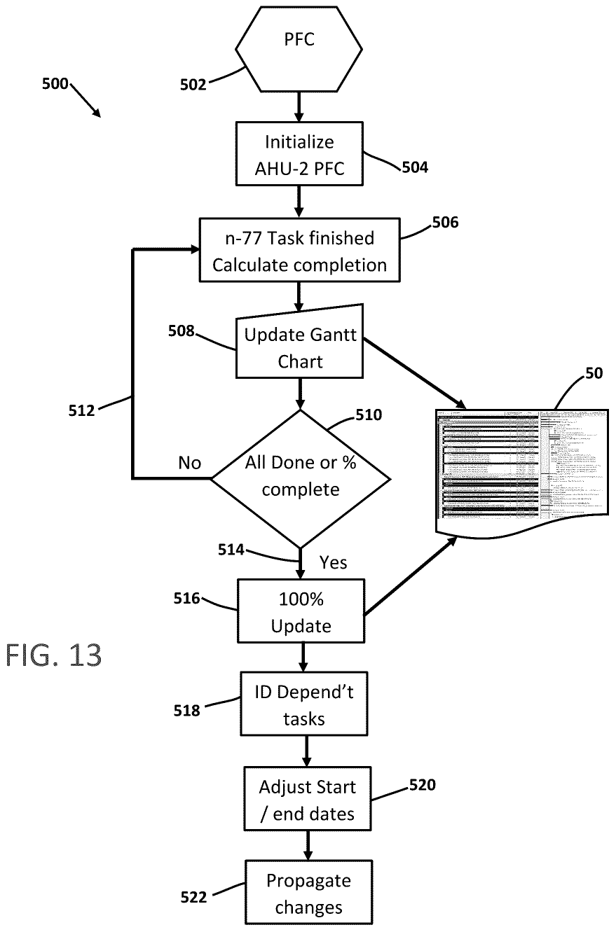

FIG. 13 is a flow chart 500 according to example 2. In this example we will assume that the that AHU-2 PFC has 77 activities, and the program is looking at a scenario where all activities are marked as “yes”. The algorithm would work specifically for AHU-2 PFC. In the setup the pre-functional checklist (PFC) for the AHU-s has the 77 activities. Each activity has a status of either ‘yes’, ‘no’, or ‘n/a’. There is a corresponding Gantt chart activity, such as GCA_AHU2 that is associated with this AHU-2 PFC 504. In the algorithm there is first an initialization 504 where the complete activities are set to 0. For each activity in AHU-2 PFC, all given activities are marked as ‘yes’ 508. As the activities are completed or incremented there is a completion percentage=(′completed activities/n)*100 506 until all ‘completed activities’ 506 are divided by 77 (since all 77 are marked ‘yes’). In this example, when all activities are completed ‘completion percentage’=(77/77)*100=100% 514, the Gantt Chart Activity 50 (GCA_AHU2) is updated 50 so the completion status to 100% since all activities in the PFC are marked ‘yes’. When the GCA_AHU2 is 100% complete** 516 it will trigger the scheduling logic to update all affected predecessors, milestones, successors, etc. in the Gantt chart 50.

The scheduling logic will identify dependent tasks for GCA_AHU2 518, adjust start/end dates based on GCA_AHU2's completion status 520 and propagate changes to subsequent tasks 522. The system should be robust enough to handle changes in the PFC, ensure a task doesn't get marked more than 100% complete and handle the Gantt chart's scheduling logic shall handle constraints and dependencies properly.

All Gantt activities that will require an associated PFC (Let's note this as a DCD or Digital Checklist Document moving forward as it could be any type of checklist associated with a relatively updating Gantt activity GCA), will have the option to link through a drop down from the GCA to the DCD project database, or for the DCD to have a drop down to a search menu of the Gantt to link to the associated GCA. The algorithm will automatically check the amount of DCD activities whether it be 1-how every many activities there are and will fit it into the GCA 0-100% with also an option to Run the overall logic of the project schedule automatically when activities reach 100% or with a user setting to allow the admin or assigned persons with access to verify first.

In a more detailed algorithm to capture this integration between the Gantt Chart Activity (GCA) and the Digital Checklist Document (DCD) there is a setup where a database or a structured list of DCD's with the same or a varying number of activities is linked to a Gantt chart with Gantt Chart Activity (GCA), wherein each GCA can optionally be linked to a DCD. In the linking process the GCA has a dropdown menu that allows a user to link the GCA to a DCD from the database. Within a DCD, a dropdown (or search menu) allows a user to link the DCD to a GCA.

In the algorithm step, there is an initialization that retrieves the DCD that is linked with the GCA. The total number of activities within the DCD is set at ‘n’ where ‘n’ denotes the number of activities. Just as in a previous example, the completion percentage is calculated 512. If the user sets the program to auto-run it will trigger the scheduled logic or it will notify the administration or assigned person for verification.

The scheduling logic is like previously described where changes and verification(s), errors, inconsistencies are propagated to all linked tasks, programs, Gantt charts etc. The system can review the DCD including pictures or images of the status from cameras 102 drones or sensors. The verification can also be manually triggered for schedule logic. The software can handle possible errors or inconsistencies that might arise, such as a DCD being linked to multiple GCAs.

Depending upon the platform and environment, the actual implementation could leverage APIs, databases, and specific project management tools. For user interfaces, the system can clear feedback mechanisms, so users know the status and results of their actions (e.g., successful linking of a DCD to a GCA). This algorithm aims to ensure a smooth linking process between DCDs and GCAs, automatic updates based on checklist completion, and the appropriate triggering of scheduling logic. The algorithm is designed to be generic and will work for both AHU-1 and AHU-2 (or any other units for that matter) as long as they have associated Digital Checklist Documents (DCDs) with activities that need tracking.

The next feature assumes that AHU-2 is the direct Successor to AHU-1 within the Gantt chart, in this example, AHU-1 shows a total of 5 days in the schedule to complete the PFC, once it is completed AHU-2 begins. If AHU takes 6 days, there will be a 1-day delay in the project until the time can be made up later, you could correct this by completing AHU-2 in 4 days to not delay the schedule. As the associated trades that are filling out the checklists, assume a mechanical subcontractor has 7 activities in the PFC/DCD and the Electrician has 3 activities, as they are not focused typically at a granular level of the schedule, there will be a window/indicator of the Gantt activities on the DCD that indicates the activity they are working on as a bar with a start and end date to bring awareness to the installing contractors. Additionally, each activity will have an expected time frame for completion based on logic, for AHU-1 you could simply calculate the 10 activities in the DCD by the 5 days allocated in the schedule, this would calculate if the first activity were to start on Jan. 3, 2024, would need to complete on January 9th by using work days. You would know activity 1 would start on 1/3/24 and activity 10 would need to end by 1/9/24. If the last activity completes on 1/10/24, the window noting schedule on AHU-2 would start on 1/11/24 and would suggest compressing the amount of time to make up the schedule.

As the activities in AHU-1 update the Gantt activity and thus the schedule when run, the data will back feed into all DCD's linked to the project reflecting the continuously updated project schedule Gantt. The feature displays critical scheduling data directly within the Digital Checklist Document (DCD) to give the trades a more informed context while filling out their checklists. This enhances their awareness of the broader project timeline and dependencies.

Algorithmic steps will set up and define properties for each GCA (Start Date, End Date, Duration). This will also define activities within each associated DCD, possibly segmented by trades. There is Gantt data integration within the DCD to show a condensed version of the GCA timeline within the DCD. Activity timeframe calculation will determine ‘time per activity’ by dividing GCA duration by the total DCD activities and assign a start and end date for each DCD activity based on ‘time per activity’. Timeframes in the DCD will be displayed beside each DCD activity, showing its calculated timeframe.

Tracking and feedback is updated on DCD completion that reflect DCD completion percentages in its associated GCA. Any impact Analysis shows if DCD activities finish late, compute the delay. Any delay is reflected in successor GCAs and their associated DCDs and may provide compression suggestions where possible to mitigate delays. There is a continuous Gantt Chart activity Sync that updates, refresh start/end dates and durations that reflect these updates in related DCDs to keep all stakeholders informed.

Notifications and delay activity alerts are reflected as DCD activity overshoots its end date, alerting the concerned trade or user. There are schedule update notifications on overarching schedule modifications that affect a DCD, notify the relevant DCD stakeholders. Implementation aspects ensure rapid updating for real-time synchronization between Gantt and DCDs. This solution provides a clear Ul for tradespeople, so they easily understand schedule impacts by using color codes or visual markers for delayed activities or compression suggestions.

There is tool and software linkage for tech stack, considers APIs, database triggers, and other integrative measures to maintain synchronicity between the Gantt chart and DCDs. This algorithm serves as a framework for the processes involved. Customizations may be needed based on the nuances of the software environment, user roles, and specific project requirements.

As each assigned DCD has an associated assigned stakeholder (i.e. tradesperson, superintendent, inspector, etc.), as the predecessors are nearing and completing, the successor-based stakeholder with an assigned activity will receive a notification of upcoming and work ready via a computer implemented method via email, text, via app through Gantt schedule or however notification is assigned. This occurs also through the GCA, with status of the Gantt activity, percentage complete, or delay. This ensures stakeholders are timely notified about the status of their tasks, upcoming tasks, or delays based on the predecessors' progress.

The algorithm and computer implemented process has a set up for each Digital Checklist Document (DCD) has an associated stakeholder. Stakeholders can include tradespeople, superintendents, inspectors, etc. Stakeholders have preferred communication channels set (e.g., email, text, app notification) and each Gantt Chart Activity (GCA) has a status, completion percentage, and any delay metrics. With initialization each GCA, retrieve its current status, completion percentage, and any associated delay with the associated DCD and its assigned stakeholder. There is an identify predecessor GCAs and successor GCAs for the current GCA.

There is a check predecessor status for each predecessor GCA. If the predecessor is nearing completion (e.g., above 80% but not yet 100%), it can trigger a ‘heads-up’ notification for the stakeholder of the successor GCA. When the predecessor is completed (100%) it will trigger a ‘work ready’ notification for the stakeholder of the successor GCA.

Notifications are sent based on the preferred communication channel of each stakeholder and can be sent as Email: Send an automated email with the notification details text: Send a text message alert with the necessary information, app Notification: If there's an associated app, push a notification to the stakeholder's device or using other methods that can be implemented based on stakeholder preference and technology availability. If there's a change in the GCA's status, completion percentage, or if there's a delay. This will send a notification to the stakeholder associated with the GCA about the update. Any delays will provide detailed information about the delay's cause, impact, and expected resolution.

The algorithm uses a feedback mechanism, so stakeholders have acknowledged notifications, ask questions, or provide updates on their end. This can be implemented via direct reply to email/text, a ‘respond’ button on app notifications, or through a portal on the Gantt schedule platform.

Implementation considerations ensure the system is timely and doesn't flood stakeholders with redundant notifications that handle errors gracefully. For instance, if a text notification fails, the system should attempt an alternative method or log the failure for manual follow-up as well as security and privacy concerns should be addressed, especially when communicating via external channels. A dashboard or report for monitoring and reporting is available for managers or admins to monitor notification statuses, stakeholder responses, and any potential issues.

For ease, and quick verification, the system will utilize digital floor plans and elevations of the project uploaded for quick reference, as stakeholders locate equipment/assets/phases etc. they can reference this virtual model. As an example, if an issue is discovered on AHU-2 DCD, the associated activity of the selected status options of Yes, No or N/A would be marked as no, adjacent to the activity field will be a box where the stakeholder will describe the issue. This can trigger multiple functions. Function 1 is to quickly link on the virtual model/floor plan or linked BIM model the location of the activity/issue. Function 2, the issue is uploaded to the “issues log” tracking matrix by overall issue number, shareholder name, company, date and status (along with DCD number) and Function 3, the Gantt chart is updated by percentage complete and now a separate color indicating incomplete driven by the No status, for example in Gantt charts the horizontal bar if filled in usually with a drained color such as red visually for complete, in this instance we can use Yellow to associate the task as No and also triggering the notification described before to affected stakeholders. This enables stakeholders to use digital floor plans and elevations for quick verification, locate assets, mark issues, and update the project's status through an integrated UX interface.

The algorithm is set up, so the system has digital floor plans, elevations, and optionally BIM model of the project uploaded with an “issues log” tracking matrix in place. The Gantt chart has colors associated with task status (e.g., red for complete, yellow for issues) so stakeholders have the ability to update the status of DCD activities.

If a stakeholder identifies an issue with a DCD, such as AHU-2 DCD, with activity 66 in the UX interface, there's an option to select a status next to the activity field (Yes, No, N/A). The stakeholder selects “No.” and adjacent to the status field is a description box. The stakeholder inputs details of the issue.

A first function is for a virtual model linkage, wherein upon issue identification the system automatically highlights the associated asset or location (e.g., AHU-2) on the digital floor plan/elevation or BIM model so stakeholders can click or hover over this highlighted area to view the specific issue details.

A second function is for an issue log update that identified issues get automatically populated into the “issues log” tracking matrix with a unique issue number, the stakeholder's name, associated company, date of identification, status of the issue, and the DCD number related to the issue.

A tertiary function is for Gantt chart updated where the Gantt chart's activity bar (for activity 66 in our example) changes color to yellow, indicating an issue. The percentage completion of the activity is updated and if the algorithm identifies affected stakeholders due to this issue (based on the dependency of tasks) the previously described notification system gets triggered to alert these stakeholders.

There is a feedback mechanism where users have the option to provide feedback on the identified issues, suggest resolutions, or indicate if the issue has been resolved. Implementation considerations are for the UX interface to be intuitive and responsive. Zoom-in, zoom-out, and panning functionalities on the floor plans/elevations/BIM models are essential for ease of use. This ensure that the color coding is consistent and universally understood (e.g., red generally indicates stop or an issue, while green often means good or complete) to prevent data overload, only major or critical issues might be highlighted directly on the virtual models, while minor ones can be listed separately.

Monitoring and reporting are provided to project managers or admins with a dashboard to oversee all reported issues, their statuses, and any actions taken and generates periodic reports for stakeholders indicating the progress and issue resolutions. Software tools and integration algorithms can be integrated into existing project management systems or BIM software platforms, so the API integration provides a seamlessly connect the issues log, Gantt chart updates, and virtual model functionalities. By integrating these algorithms and methods, the system enhances stakeholder communication, offers real-time problem identification, and facilitates quick action, leading to efficient project management and timely resolution of issues.

Typically, an expert in scheduling will review the provided design documents and will start from scratch with a Gantt based scheduling software such as Oracle's P6 and Microsoft Project, they will go through and detail every major activity of a construction project from grading to installing the roof to completion/occupancy, often there are hundreds to thousands of GCA's. On the other end of the spectrum DCD's are typically created with quality control, and inspections in mind, in this example a commissioning agent has created a digital document with many AHU's associated with the project, they would also create DCD's for all major assets in the scope, this usually ranges from Mechanical systems assets such as Air Handling Units or AHU's, Terminal Units or TU-'s, Exhaust Fans or EF's etc. For Electrical there would often be assets such as Automatic Transfer Switches or ATS's, Exhaust Fan's or EF's etc. Each of these specialized consultants, trades and various stakeholders would work within the Gantt section of the software with the user interface they are accustomed to and could complete their scope of what would normally be utilized.

The integration of our solution allows for a few scenarios, scenario 1: Scheduler completes Gantt chart, Cx Agent completes all DCDs in their associated software section. Once complete Either the Scheduler can click a relevant DCD such as AHU-1 in the Gantt chart, with a field to link to DCD, as the DCD menu opens there are multiple selections such as System, in this case Mechanical (other options include electrical, or any populated within the DCD's created) followed by Air or Water, Air would be selected opening options for AHU's, TU's EF's etc. Then you could select 1 or Multiple (for example some GCA's may be generic and thus show AHU's for example, if you select multiple, you could then link to multiple DCD's of AHU's 1-2 for example and the activity would aggregate the two across the combined GCA, this would also open as an option a subset of Gantt activities as a drop down if desired for scheduler to see granular status), however in this instance the schedule would select AHU-1 thus linking the DCD to the GCA.

In scenario 2, the Scheduler could link to a template through the drop-down menu of an AHU or AHU-1 thus creating a DCD from a suite of templates within the software suite. This would allow the Cx Agent to build out the specifics to the DCDs with relevant questions in an already linked document populated with schedule logic links.

In scenario 3, The Cx Agent could build out all of the assets, by identifying by area etc., and then through a drop-down menu open up a view of the Gannt chart and either a. Link the DCD to the associated GCA or create an GCA place holder for the schedule to place in the logical order relative to other successors and predecessors.

The computer implemented method and algorithms seamlessly integrate DCDs with GCAs, allowing schedulers and commissioning agents to interlink their tasks for efficient project management. Upon initialization the device will load the GCA platform with features like task creation, sequencing, dependencies, and calendar integration and load the DCD platform with asset classifications (e.g., Mechanical, Electrical), sub-classifications (e.g., Air, Water), and specific assets (e.g., AHU-1, EF-3) for both platforms should allow for searching, sorting, and filtering tasks/assets.

In scenario 1 the scheduler initiates DCD-GCA links wherein once a GCA task is created, there's an option for “Link to DCD.” When this menu is selected, the menu allows for selection of a system: e.g., Mechanical, a sub-system: e.g., Air, for a specific asset or multiple assets: e.g., AHU-1, TU-2. If multiple assets are selected, the system aggregates the status across them and a subset of related GCA tasks (if any) can be viewed as a dropdown for granular status checks.

In scenario 2 there is a scheduler that uses DCD templates and as schedulers build out the GCA, they have an option to “Link from Template.”. Selecting this gives access to predefined DCD templates, like AHU or ATS and once linked, the template acts as a placeholder, with the commissioning agent later customizing specific questions or parameters. The populated DCDs inherit the GCA's schedule logic links, ensuring a cohesive project timeline.

In scenario 3 the Cx agent initiates GCA-DCD links and after detailing the assets in the DCD platform the Cx Agent has an option to “Link to GCA” or “Create GCA Placeholder.”. If “Link to GCA” is chosen, a view of the Gantt chart appears for direct linking. If “Create GCA Placeholder” is chosen, a temporary task is generated in the Gantt chart, which the scheduler can later adjust for proper sequencing and dependency.

There are automatic notifications and updates wherein upon any linking or changes, relevant stakeholders receive automatic notifications the Gantt chart and DCD dashboard continuously sync, reflecting real-time progress and status updates. The algorithm includes validation and error handling wherein if a DCD link attempt is made to an unrelated GCA, the system warns the user. Periodic checks ensure no orphan DCDs (i.e., DCDs not linked to any GCA) exist. If found, reminders are sent to stakeholders to establish links.

Insights and reports display linked DCDs and GCAs, progress percentages, and any discrepancies or issues to provide insights into potential delays or bottlenecks based on the interlinked tasks. This ensures a user-friendly interface for both schedulers and commissioning agents. The system should be scalable, handling projects with a few tasks to those with thousands. Integration ensures data integrity and avoid duplication and integrates with popular scheduling software like Oracle's P6 and Microsoft Project under a single point solution as a transformative solution in construction management by reimagining workflows for enhanced collaboration, efficiency, and adaptability.

Users are provided with the computer implemented scheduling system as a service through a network. This system is implemented using various means such as a hardware model, a sole software model including firmware, resident software, micro-code, etc., or a model that integrates both software and hardware elements. These often manifest as a “circuit,” “module,” or “system.”.

The implementation of this scheduling system can be realized as a computer program product encompassed in one or more computer-readable mediums with embedded computer readable program code. A computer-readable medium refers to any product, device, or apparatus (magnetic disks, optical disks, memory, or Programmable Logic Devices) used to supply machine instructions or data to a programmable processor. This includes a machine-readable medium that receives machine instructions as a propagated signal.

Program code for executing operations of this scheduling system can be written in any combination of one or more programming languages. These may include high-level procedural and/or object-oriented programming languages or in assembly/machine language, and the code may run entirely on the user's computer, partially on the user's computer, as a stand-alone software package, partially on the user's and partially on a remote computer, or entirely on a remote computer or server.

These computer programs, also known as software, software applications, code, or programs, contain machine instructions for a programmable processor. They can be written in an object-oriented programming language such as Java, Smalltalk, C++, Python, or similar, as well as a procedural programming language like the “C” programming language.

Unless explicitly stated otherwise, terms such as “processing,” “computing,” “calculating,” “determining,” “displaying,” “providing,” or similar terminology refers to actions and processes executed by a computer system or similar electronic computing device. These actions manipulate and transform data represented as electronic quantities within the computer system's memories, registers, or other storage, transmission, or display devices.

To illustrate the architecture, functionality, and operation of potential implementations of systems, methods, and computer program products, they can be described with reference to the flowchart illustrations and/or block diagrams. However, the logic flows depicted do not necessitate the precise order or sequential arrangement shown to achieve favorable results.

It's worth acknowledging that the detailed embodiments provided earlier are merely examples or potential embodiments of the scheduling system, and numerous other combinations, additions, or alternatives are plausible. The specific naming conventions for components, attributes, data structures, or any other programming or structural elements are also not obligatory or significant.

The mechanisms that implement the subject matter, or its features, may have different names, formats, or protocols. Additionally, the system can be implemented using a combination of hardware and software or solely with hardware components. The division of functionality among the various system components as described here is for illustrative purposes and is not set in stone.

Lastly, while this disclosure has been described in the context of various specific embodiments, it's important to recognize that it can be practiced with modifications within the spirit and scope of the claims.

Thus, specific embodiments of an automatically updating scheduling software with notification & alerts have been disclosed. It should be apparent, however, to those skilled in the art that many more modifications besides those described are possible without departing from the inventive concepts herein. The inventive subject matter, therefore, is not to be restricted except in the spirit of the appended claims.

1. A automatically updating scheduling software with notification & alerts comprising:
a screen having summary screen status view of a construction project;
said summary screen status view being configured to allow for viewing of at least a portion of said construction project;
said of at least a portion of said construction project being linked to at least a Gantt, critical path method (CPM), program evaluation & review technique (PERT), kanban, scrum, agile release train (ART), time-boxing, burndown charts or story mapping, feature-driven development (FDD), that includes at least one construction operation within said of at least a portion of said construction project and at least one inspection of said of at least a portion of said construction project;
said at least one inspection allows for local or remote release of a successive activity of said construction project activities;
whereby said virtual view of said construction project and said Gantt chart are updated simultaneously.

2. The automatically updating scheduling software with notification & alerts according to claim 1, wherein said virtual view of said construction project is created from architectural plans.

3. The automatically updating scheduling software with notification & alerts according to claim 1, wherein said updated simultaneously is from a cloud-based application that includes a Geo-Spatial location.

4. The automatically updating scheduling software with notification & alerts according to claim 1, further includes at least one of a schedule, an inspection, a building permit, a building material order sourcing, a design, an estimate, a submittal, a pre-construction and a construction post construction, agriculture, military operation, corporate management, software development, product development, pharmaceuticals, manufacturing, aerospace, insurance, and automotive scheduling.

5. The automatically updating scheduling software with notification & alerts according to claim 4, wherein said update is with simultaneously links to said schedule to at least one of said documents.

6. The automatically updating scheduling software with notification & alert according to claim 1, wherein said application provides for entry of information about schedule task status by audio input or video input.

7. The automatically updating scheduling software with notification & alerts according to claim 6, wherein said method further comprises parsing said audio input or said video input is by using artificial intelligence or human or a combination thereof.

8. The automatically updating scheduling software with notification & alerts according to claim 6, wherein said method is through sensors that are trade mounted, stationary or UAV.

9. The automatically updating scheduling software with notification & alert according to claim 6, wherein each task has a weighted and an assigned relative value.

10. The automatically updating scheduling software with notification & alert according to claim 1, wherein said scheduling software includes a process that orders said weighted and said assigned relative value in a correct order and should said construction project experience delays, said scheduling software will utilize linked predecessor and successor logic, to logically reoriented activities.

11. A computer-implemented method of automating schedule updates, notification,
observations, reporting and data linking the computer-implemented method comprising:
a primary observer manually entering data into an application on a mobile cellular device corresponding to a status of completion of an activity;
said data including an entered location into said application on said mobile cellular device;
receiving a primary observer report time from said mobile cellular device;
merging said completion of said activity from said primary observer, a report time into to make a set of merged data;
based on said set of merged data, calculating a percentage of completion based upon an expected completion data and an actual completion date of said activity;
comparing a location of said primary observer with design documents, architectural location merged with said report time of said activity of an activity completion, and
a server sending a push notification alert with a report time that indicates how long ago said report time was posted.

12. The computer-implemented method according to claim 11, further includes at least one of a schedule, an inspection, a building permit, a building material order sourcing, a design, an estimate, a submittal, a pre-construction activity, and a construction post construction activity.

13. The computer-implemented method according to claim 11, wherein said automating schedule updates are simultaneously links to said schedule to at least one of said documents.

14. The computer-implemented method according to claim 11, wherein said method provides for entry of information about schedule task status via audio input or video input.

15. The computer-implemented method according to claim 11, wherein said method further comprises parsing said audio or said video using artificial intelligence or human or a combination thereof.

16. The computer-implemented method according to claim 11, wherein said method is through sensors that are trade mounted, stationary or UAV.

17. A computer-implemented method of automating schedule updates, notification,
observations, reporting and data linking the computer-implemented method comprising:
a recording observation mechanism that enters data into an application over a network wherein said observation mechanism records and documents a status of completion of an activity;
said status of completion is a report including a virtual or augmented recording that is viewable in real time or at a future time;
merging said virtual or augmented recording with a report time and date to make a set of merged data;
based on said set of merged data, calculating a percentage of completion based upon an expected completion data and an actual completion date of said activity;
comparing a location of said recording observation mechanism with design documents, architectural location merged with said report time of said activity of an activity completion, and
a server sending a push notification alert with a report time that indicates how long ago said report time was posted.

18. The computer-implemented method according to claim 17, further includes at least one of a schedule, an inspection, a building permit, a building material order sourcing, a design, an estimate, a submittal, a pre-construction and a construction post construction.

19. The computer-implemented method according to claim 17, wherein said update simultaneously links to said schedule to at least one of said documents.

20. The computer-implemented method according to claim 17, wherein said application provides for entry of information about schedule task status via audio input or video input.

21. The computer-implemented method according to claim 17, wherein said method further comprises parsing said audio or said video using artificial intelligence or human or a combination thereof.

22. The computer-implemented method according to claim 17, wherein said method is through sensors that are trade mounted, stationary or UAV.
